(19) United States
(12) Patent Application Publication
(10) Pub. No.: US 2006/0106896 A1
(43) Pub. Date: May 18, 2006

(54) System and method for creating list of backup files based upon program properties

(75) Inventors: Michael P. Carlson, Austin, TX (US); Herman Rodriguez, Austin, TX (US)

Correspondence Address: Greg Goshorn, P.C., 2110 W. Slaughter lane, SUITE 115-119, AUSTIN, TX, 78748, US

(73) Assignee: INTERNATIONAL BUSINESS MACHINES CORPORATION, ARMONK, NY (US)

(21) Appl. No.: 10/988,459

(22) Filed: Nov. 12, 2004

(51) Int. Cl. G06F 12/00; G06F 17/30

(52) U.S. Cl. 707/204

(57) ABSTRACT

Provided is a method for creating comprehensive backup files in a computing system on an application by application basis. An application is selected for backup and the output of the application is monitored with regard to the creation and modification of files. Files designated for backup may be stored on the same computer system as the selected application or accessible via a network. A properties menu enables a user to designate a particular application, either at the time of installation, retroactively or subsequently, as a “backup monitor” application by setting an application monitor flag within a configuration file associated in the alternative with the application, the operating system or with the backup monitor application. In addition, a number of security settings, or “filters,” may be designated to cull the files listed for backup based upon some property of the file.

### TECHNICAL FIELD

The present invention relates generally to computer file management and, more specifically, to a method of creating a comprehensive backup of files related to a specific application.

### BACKGROUND OF THE INVENTION

Computer data is typically organized into files and directories and stored in electronic format on various memory devices. Programs, or “applications,” are a particular type of computer data that typically contain both executable instructions and data storage areas. During execution, applications use various computer files for input and generate computer files as output. Further, both input and output files may include information such as, but not limited to, data and configuration information. Specific data and configuration information is often essential for the proper functioning of a particular application. One issue in computer reliability is the availability of the proper data and configuration information that an application needs to execute properly.

Another computer reliability issue involves the integrity of both input and output information. Since computer memory can become corrupted, system administrators typically backup primary computer memories onto secondary computer memories. A backup can be total, i.e. all files of the primary memory are stored in the secondary memory, or selective, also known as “partial” or “delta,” i.e. only selected files are copied. Although a total backup may save all necessary data, such a procedure can consume large amounts of both computer memory and time, especially if performed on a regular basis. A selective backup mitigates the memory and time issues but can create a problem if all necessary files are not selected for the procedure.

A partial backup is based upon a list of subject files and/or directories. In one example, a list is generated by a system administrator. In a second example, a list is generated automatically based upon a file by file determination of whether or not a particular file has been either modified or “touched,” i.e. accessed. In the first example, a system administrator may inadvertently omit an important or essential file. In the second example, a complete scan of a file system is required, a procedure that is typically only performed on an entire memory medium. Of course, additional issues arise when files are distributed across a network.

What is lacking in the current art is a reliable method for performing a backup on an application by application basis. In other words, computer system administrators could use a backup system that enables a specific application to be designated as backup target, a method which can be executed automatically and is guaranteed to record all the necessary files and/or directories related to the particular application.

### SUMMARY OF THE INVENTION

Provided is a method for creating comprehensive backup files in a computing system on an application by application basis. An application is selected for backup and the output of the application is then monitored with regard to the creation and modification of files. The type of file involved includes, but is not limited to, application, user and system files. File type examples include application executable and data files, created or modified log files, system setting and configuration files and application configuration files. Affected files may be stored on the same computer system as the selected application or accessible via a network.

A properties menu includes an option that enables a user to designate a particular application, either at the time of installation or retroactively or subsequently, as a “backup monitor” application by setting an application monitor flag within the application's configuration file. An application so designated is then monitored by a backup monitor application. In addition, the user can specify one of a number of security settings, or “filters,” for the backup monitor. For example, one filter may specify that new, changed and deleted files are to be included in the particular application's backup. Another filter may specify that any “touched” file should be included. Another filter may specify only files located on the local system be included. One with skill in the programming and/or computing arts should recognize that many possible filters, both mutually and non-mutually exclusive, are possible.

An application manager determines whether or not to initiate a backup monitor for a particular application when the application is initiated based upon the setting of the application monitor flag in the application's configuration file, a system configuration file such as the Window's registry or within a configuration file of the backup monitor application. In an alternative embodiment, one backup monitor serves to perform the claimed subject matter with respect to multiple applications and the application manager merely notifies the backup monitor that a designated application has been initiated. The backup monitor watches the application for files opened, modified, created, touched, and so only the application and, depending upon filter settings, lists relevant files to a backup list.

Many applications create and modify files unbeknownst to the user. These files may be required when a user migrates to a new system, performs a partial (or delta) backup, or to perform a comprehensive backup of a system or application. One issue that arises in these circumstances is that, in the process of performing a backup, a user may miss backing up a file of which the user is unaware. The claimed subject matter mitigates the chance of such an omission from occurring by automatically creating a list of all files, both known and unknown, necessary for a comprehensive backup.

### BRIEF DESCRIPTION OF THE DRAWINGS

A better understanding of the present invention can be obtained when the following detailed description of the disclosed embodiments is considered in conjunction with the following drawings, in which:

FIG. 1 is a block diagram of a computing system architecture that supports the claimed subject matter.

FIG. 2 is a block diagram of a backup monitor introduced in FIG. 1.

FIG. 3 is a flowchart of an initiation procedure of the backup monitor of FIGS. 1 and 2.

FIG. 4 is a flowchart of the normal operation of the backup monitor of FIGS. 1-3.

FIG. 5 is an illustration of an Application page of an exemplary, graphical user interface (GUI) for designating applications for inclusion in the claimed backup monitor functionality.

FIG. 6 is an illustration of a Special Files page of the exemplary, graphical user interface (GUI) for designating particular files for inclusion in the claimed backup monitor functionality.

FIG. 7 is an illustration of an Options page of the exemplary, graphical user interface (GUI) for setting options associated with the claimed backup monitor.

### DETAILED DESCRIPTION OF THE FIGS.

Although described with particular reference to an application backup system in the Windows operating system, published by the Microsoft Corporation of Redmond, Wash., the claimed subject matter can be implemented in any information technology (IT) system in which the backup of program and data files is desirable. Further, the claimed subject matter is not restricted to data storage architectures that employ directories and files. For example, proposed operating systems include database structures rather than files and directories. The disclosed technology is equally applicable in a database-oriented memory architecture. Those with skill in the computing arts will recognize that the disclosed embodiments have relevance to a wide variety of computing environments in addition to those described below. In addition, the methods of the disclosed invention can be implemented in software, hardware, or a combination of software and hardware. The hardware portion can be implemented using specialized logic; the software portion can be stored in a memory and executed by a suitable instruction execution system such as a microprocessor, personal computer (PC) or mainframe.

In the context of this document, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic, infrared or semiconductor system, apparatus or device. Memory an recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

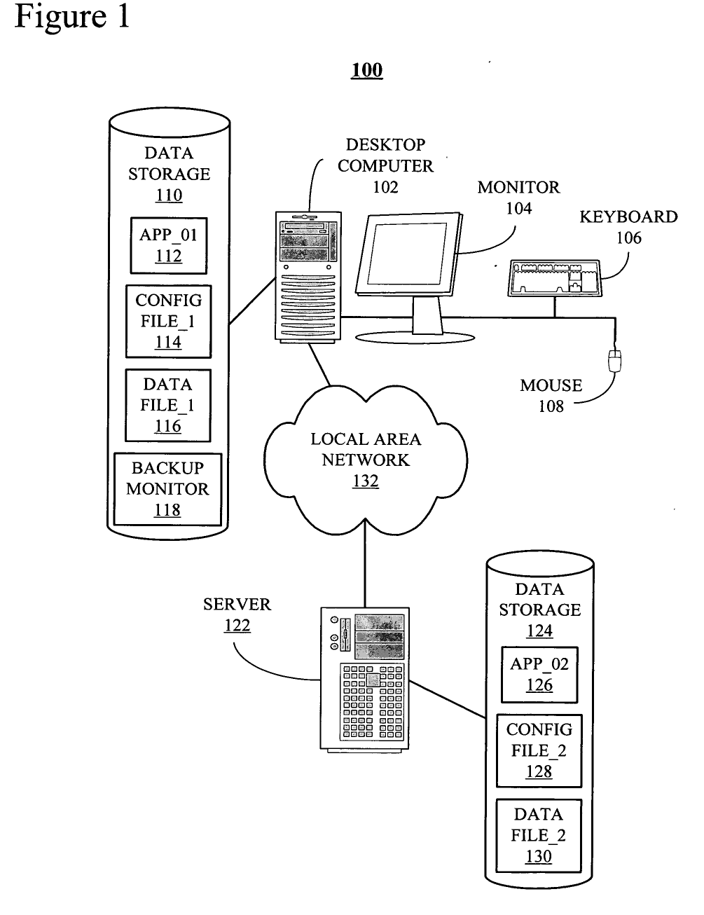

Turning now to the figures, FIG. 1 is a block diagram of an exemplary computing system architecture 100 that incorporates the claimed subject matter. A desktop computer 102 includes a monitor 104, a keyboard 106 and a mouse 108, which together facilitate human interaction with computer 102. Attached to computer 102 is a data storage component 110, which may either be incorporated into computer 102 i.e. an internal device, or attached externally to computer 102 by means of various, commonly available connection devices such as but not limited to, a universal serial bus (USB) port (not shown).

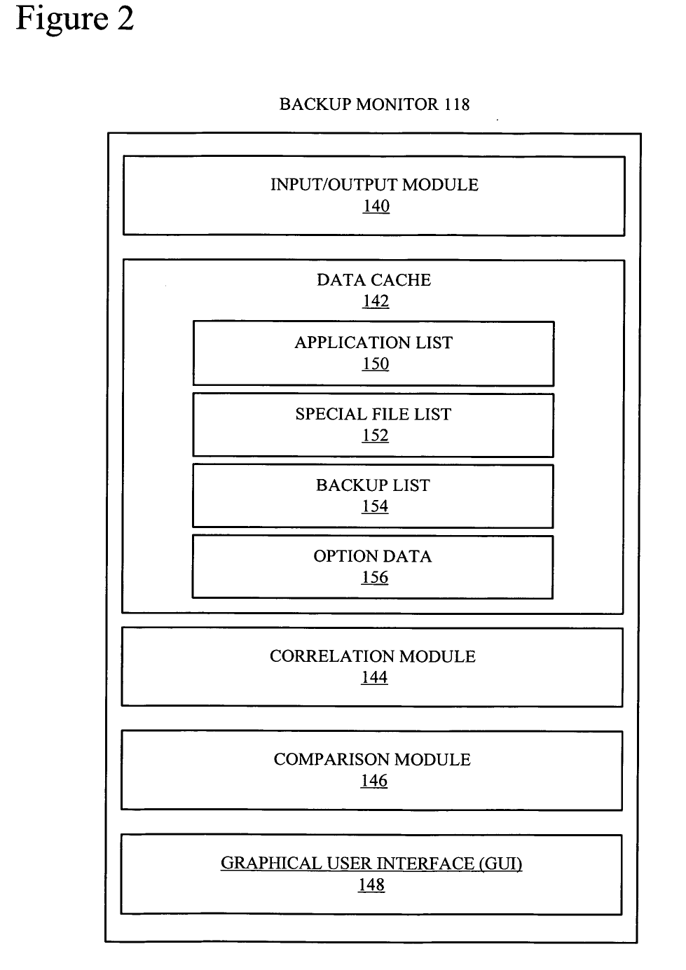

In this example, data storage 110 stores an exemplary application, App_01 112, a configuration file, Config File_1 114, a data file, Data File_1 116, and a backup monitor program 118 that provides the functionality of the claimed subject matter. App_01 112, Config File_1 114, and Data File_1 116 are used as examples in the following description. It should be understood that a typical computer system has multiple application files, data and configuration and data files. Types of configuration files include, but are not limited to, application configuration files, operating system (OS) configuration files, and various registries for the storage of information on the resources of computer 102. Backup monitor 118 is described in more detail below in conjunction with FIGS. 2-5.

A server computer 110 is attached to a data storage component 124, which, like data storage 110, may be an internal or external device. In this example, data storage 124 stores a program file, App_02 126, a configuration file, Config File_2 128 and a data file, Data File_2 130. App_02 126, Config File_2 128, and Data File_2 130 are used as examples in the following description. As mentioned above, a typical computer system has multiple application files, data and configuration and data files. Server 110 and computer 102 are communicatively coupled via a local area network (LAN) 132.

FIG. 2 is a block diagram of backup monitor 118, introduced above in FIG. 1, in greater detail. Backup monitor 118 includes an input/output (I/O) module 140, a data cache component 142, a correlation module 144, a comparison module 146 and a graphical user interface (GUI) module 148. For the sake of the following examples, backup monitor is assumed to execute on computer 102 (FIG. 1) and stored in data storage 110 (FIG. 1). It should be understood that the claimed subject matter can be implemented in many types of computing systems and data storage structures but, for the sake of simplicity, is described only in terms of computer 102 and system architecture 100 (FIG. 1). Further, the representation of backup monitor in FIG. 2 is a logical model. In other words, components 140, 142, 144, 146 and 148 may be stored in the same or separates files and loaded and/or executed within system 100 either as a single system or as separate processes interacting via any available inter process communication (IPC) techniques.

I/O module 140 handles any communication backup monitor 118 has with other components of system 100. Data cache 142 is a data repository for information, including settings and lists, that backup monitor requires during normal operation. Examples of the types of information stored in data cache 142 include an application list 150, a special file list 152, a backup list 154 and option data 156. Application list 150 stores the names of programs or applications that have been designated as targets of backup monitor 118. Special files list 152 stores the names of accessed files that should be backed up regardless of whether or not a target application was the application that accessed the file. For example, some configuration files may be accessed by multiple applications, some of which are target applications and some of which that are not. A user may determine that such a file needs to be backed up any time that particular file is accessed.

Backup list 154 is a list of the names and paths of files that backup monitor 118 has determined require backup at an appropriate time. Backup monitor 118 periodically mirrors list 154 to an area of data storage 110 or to some other memory area outside of data cache 142 so that, in the event of an unexpected termination of backup monitor 118, the information stored in backup list 154 is not lost. Option data 156 includes information on various user preferences that have been set. For example, a user may determine that only files stored in local memory and not in remote memory should be backed up.

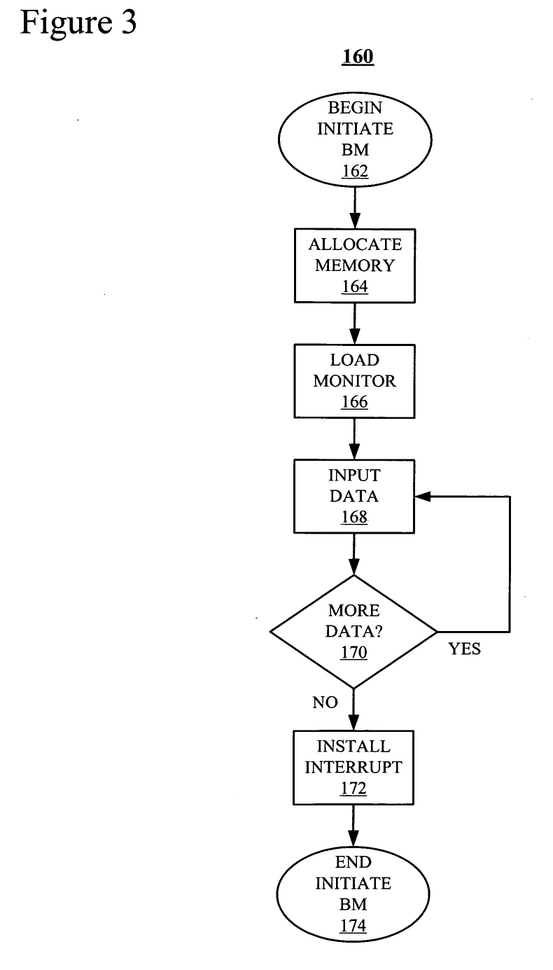

Correlation module 144 transforms information from the OS about a particular process that has accessed a file into information corresponding to applications that have been designated as targets for backup monitor 118. Comparison module 144 includes logic for determining whether of not a memory access request detected on, in this example, computer 102 necessitates an inclusion in backup list 152. Components 142, 144, 146, 148, 150, 152, 154 and 156 are described in more detail below in conjunction with FIGS. 3-5.

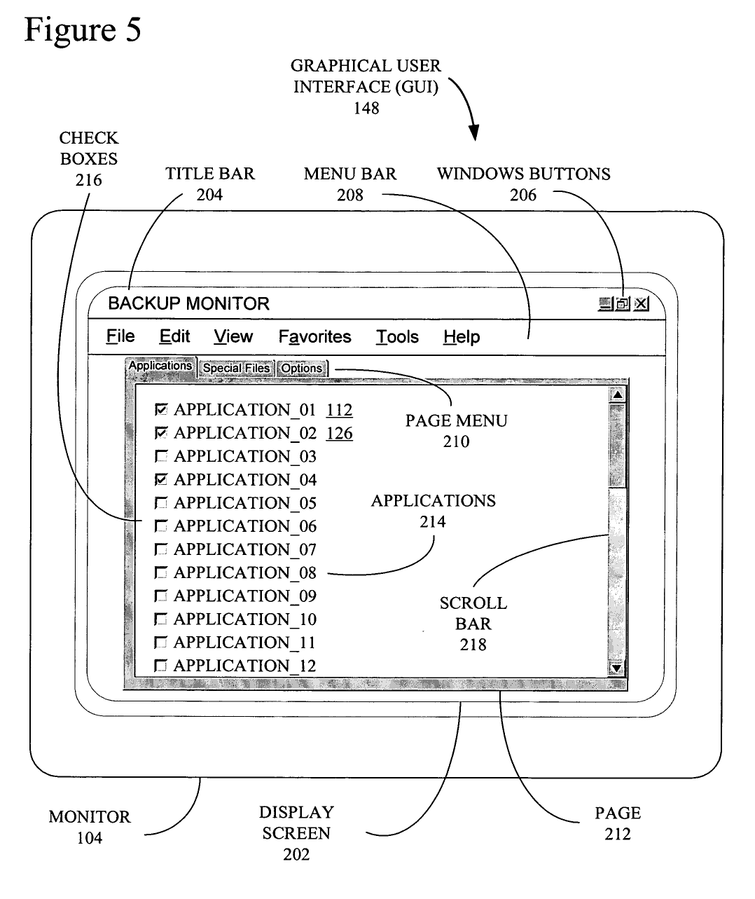

GUI component 148 enables users of backup monitor 118 to interact with and to define the desired functionality of backup monitor 118. GUI component 148 is described in more detail below in conjunction with FIG. 5.

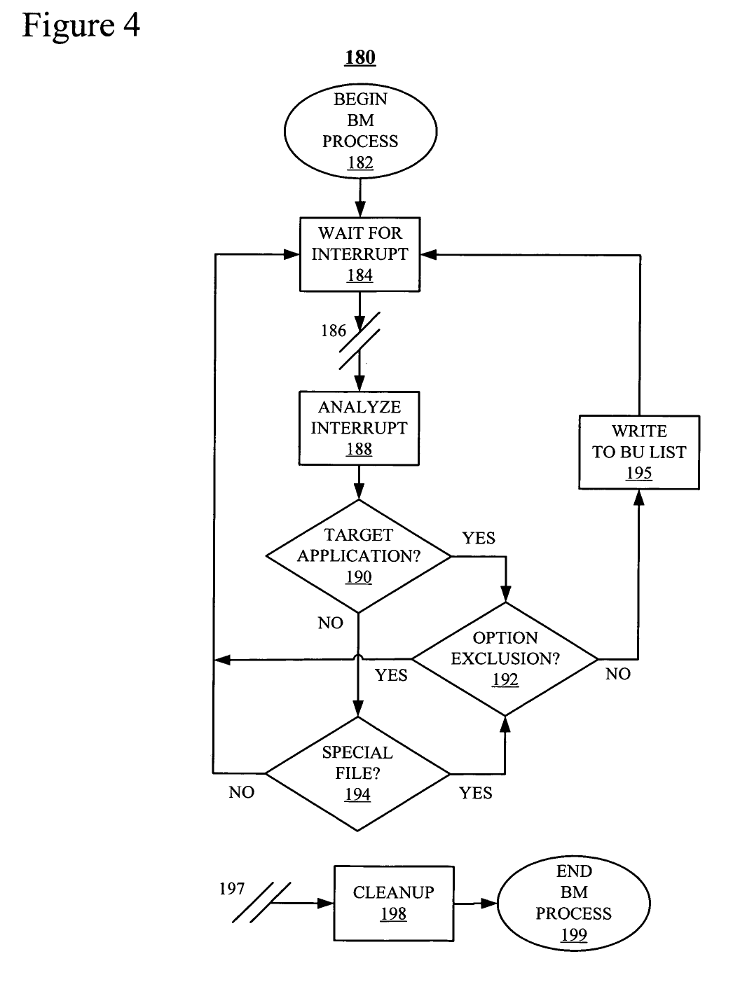

FIG. 3 is a flowchart of an Initiation, or startup, procedure 160 of backup monitor 118 of FIGS. 1 and 2. Procedure 160 starts in a “Begin Initiate Backup Monitor (BM)” block 162 and control proceeds immediately to an “Allocate Memory” block 164. During block 164, process 160 allocates memory space within computing system 102 for the backup monitor 118. In one embodiment, backup monitor 118 is an integrated function of the operating system (OS), which in this example is a version of Windows published by the Microsoft Corporation. Backup monitor 118 would thus be initialized when computer system 102 is powered on and the OS is loaded. In a second embodiment, backup monitor 118 is a stand alone program that is initialized as part of an OS startup procedure. In this second embodiment, backup monitor 118 receives signals from the OS when files are accessed as illustrated below in conjunction with FIGS. 3 and 4. Once memory is allocated, either during OS initialization or during an OS startup procedure, process 160 proceeds to a “Load Monitor” block 166, during which backup monitor 118 is loaded into the memory allocated in block 164.

Once backup monitor 118 is loaded, process 160 proceeds to an “Input Data” block 168, during which, the first time through block 168, process 160 retrieves a backup monitor configuration file (not shown) from data store 110. The backup monitor configuration file contains information such as the names and locations of other files necessary for the operation of backup monitor 118 and information concerning display options for backup monitor 118. Process 160 then proceeds to a “More Data” block 170, during which process 160 determines whether or not there are more files to be retrieved from data store 110. Whether or not there are other files to be retrieved are determined by the contents of the backup monitor configuration file retrieved during the first iteration through block 168. Examples of other files that need to be retrieved include a list of applications that have been designated as targets of backup monitor 118. Applications are designated by means of GUI 146, which is illustrated in FIG. 5.

If process 160 determines during block 170 that more data files are necessary for the operation of backup monitor 118, then control returns to Input Data block 168, the next file is retrieved and control proceeds as described above. If process 160 determines during block 170 that all the necessary configuration and data files have been retrieved, then process 160 proceeds to an “Install Interrupt” block 172, during which process 160 loads an OS interrupt service routine (ISR) to notify backup monitor when the OS receives a request to access a file. Those with skill in the computing arts should understand the installation and operation of OS interrupts. Finally, process 160 proceeds to an “End Initiate Backup Monitor” block 174 in which process 160 is complete and backup monitor is operational as described below in conjunction with FIG. 4.

FIG. 4 is a flowchart of a procedure 180 that represents the normal operation of backup monitor 118 of FIGS. 1 and 2. Process 180 starts in a “Begin Backup Monitor Process” block 182 and control proceeds immediately to a “Wait for Interrupt” block 184. Since process 180 is interrupt driven, process enters a sleep state while waiting for an interrupt signal. The expected signal corresponds to a signal from the ISR installed in Install Interrupt block 172 (FIG. 3). As explained above, the ISR is triggered by the OS when there is any type of file access. Types of file accesses may include file creation, modification and deletion. When an interrupt occurs, as indicated by an interrupt 186, process 180 awakens and proceeds to an “Analyze Interrupt” block 188.

Currently, some OSs include only the capability to detect, and thus signal backup monitor 118, when changes occur at a directory level rather than a file level. In this case, Analyze Interrupt block 188 includes logic to determine which file in a particular directory has been accessed. Block 188 employs correlation module 144 (FIG. 2) to determine the process identifier (PID), task name or application name that initiated the file access and to correlate this information to the data stored in application list 150 (FIG. 2).

Process 180 then proceeds to a “Target Application?” block 190 during which process 180 determines whether or not the application, as determined in block 188, that caused the interrupt is an application listed in application list 150 (FIG. 2) as an application to be monitored. If so, then process 180 proceeds to an “Option Exclusion?” block 192.

If in Target Application? block 190, process 180 determines that the file access that caused the interrupt was not the result of a file listed in application list 150, then control proceeds to a “Special File?” block 194 during which backup monitor 118 determines whether or not the accessed file is a file that is listed in special file list 152 (FIG. 2) as a file that should be backed up regardless of whether or not the program or application that accessed the file is listed in application list 150. If the file is not special, control returns to Wait for Interrupt block 184 and processing continues as described above. If process 180 determines during block 194 that the accessed file is listed in special file list 152 then control proceeds to Option Exclusion? block 192.

During Option Exclusion? block 192, process 180 determines whether or not there is a reason not to include the accessed file in backup list 154 (FIG. 2). The determination of block 192 is based upon information stored in option data 156, which includes information such as, but not limited to, whether or not the user who defined the information in option data 156 (see FIG. 5) specified that only files local to computing system 102 should be backed up. If process 180 determines that information in option data 156 precludes the back up of the accessed file, then control returns to Wait for Interrupt block 184 and processing continues as described above.

If process 180 determines that there is no option that precludes the inclusion of the accessed file in backup list 154, then control proceeds to a “Write to List” block 195 during which the name and path of the particular file that was accessed is added to backup list 152 (FIG. 2) so that the file is backed up at an appropriate time. Finally, from block 195, process 180 returns to Wait for Interrupt block 184 and processing continues as described above.

During normal operation, process 180 does not terminate but rather executes a permanent loop, as described above. Therefore to gracefully terminate process 180 another interrupt 197 is employed. Upon receipt of interrupt 197, process 180 proceeds to a “Cleanup” block 198 during which process 180 saves application list 152, special file list 152, backup list 154 and option data 156 to a non-volatile area of data storage 110 (FIG. 1) and releases memory allocated in Allocate Memory block 164 (FIG. 3). Control then proceeds to an “End Backup Monitor Process” block 199 in which process 180 is complete.

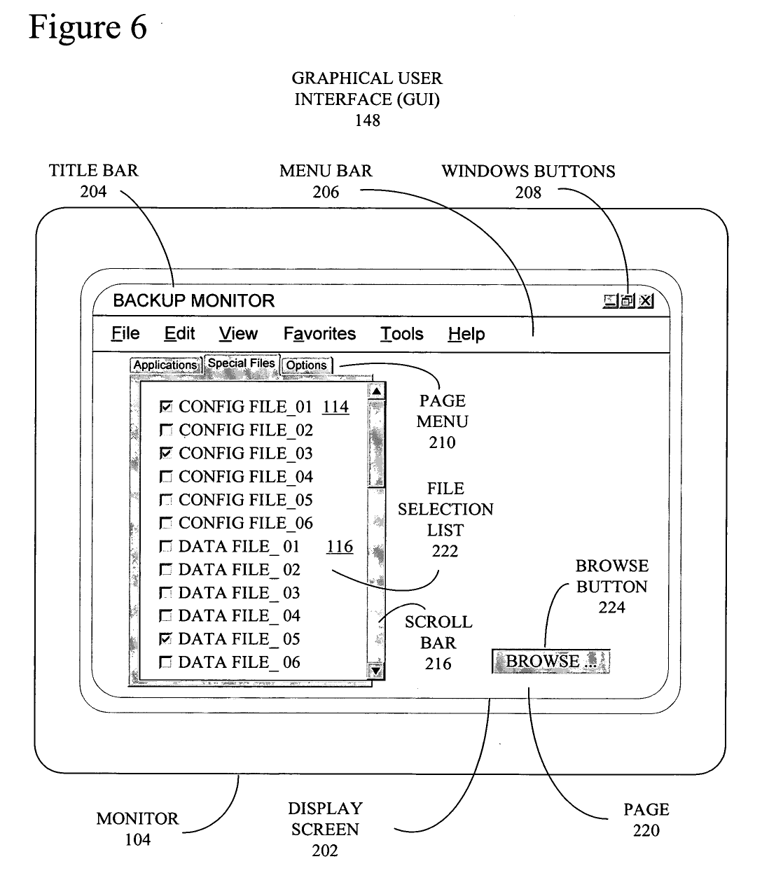

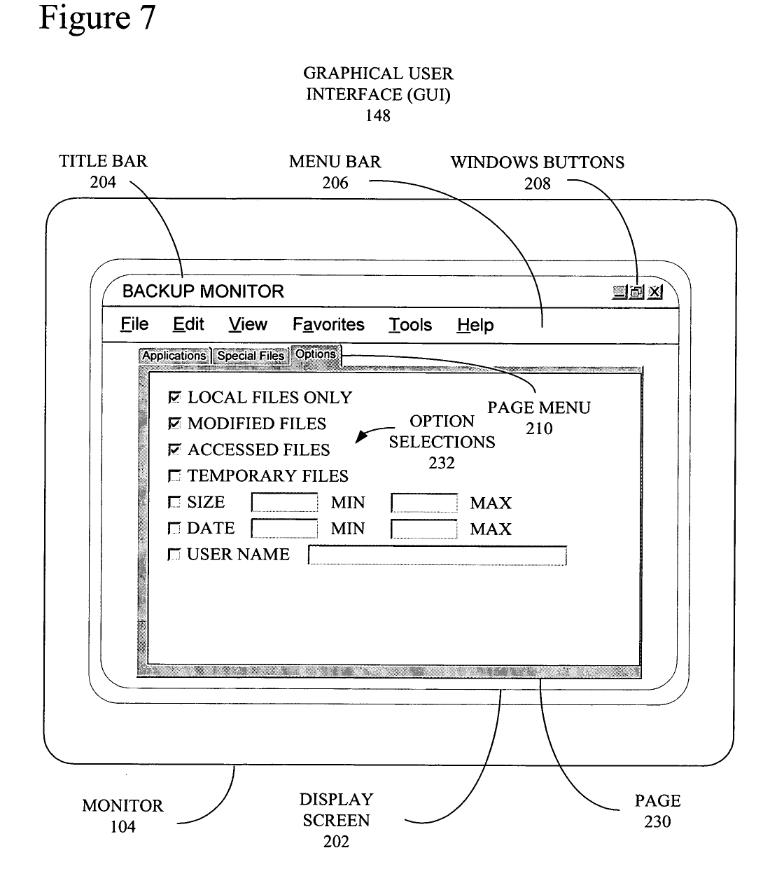

FIG. 5 is an illustration of monitor 104 (FIG. 1) with an exemplary, page 212 of graphical user interface (GUI) 148 (FIG. 2). Page 212 is employed to designate applications for monitoring by backup monitor 118 (FIGS. 1 and 2). A second page 220 of GUI 148 is illustrated in FIG. 6 and a third page 230 of GUI 148 is illustrated in FIG. 7.

In this example, a display screen 202 includes a title bar 204 that lists the name of a displayed program, or “Backup Monitor.” As is typical in Window applications, title bar 204 may include several windows buttons 206, or a “Minimize” button, a “Restore” button and an “Exit” button. Below title bar 204 is a menu bar 208, which may include a “File” option, “Edit” option, “View” option, “Favorites” option, “Tools” option and “Help” option. The standard look and feel of Microsoft Window applications should be familiar to those with skill in the art.

A page menu 210 presents a user with a choice of pages for the configuration of different options. In this example, the three choices, each represented as a tab in page menu 210, are “Applications,” which is positioned forward among the tabs, indicating that page 212 is displayed in this figure, “Special Files,” which is displayed in a page 220 of FIG. 6, and “Options,” which is displayed in a page 230 of FIG. 7.

Within page 212 on display screen 202, a list of application 214 and corresponding checkboxes 216. List of applications 214 is generated by backup monitor 118 by means of a scan of the data storage 110 and any other non-volatile memory resources of computer 102 (FIG. 1). Simply stated, backup monitor 118 searches for files with a “.exe” or “.bat” extension, although it should be noted that there are other extensions and more sophisticated methods of determining executable files on a computer system. Any current or yet to be devised method for identifying and categorizing files is applicable to the claimed subject matter. For example, the Windows Registry can be scanned or, in a RedHat Linux installation, the RPM Package Manager (RPM) database can be queried.

A user may select or deselect for monitoring by backup monitor 118 a particular application from the list of applications 214 by marking or unmarking respectively a corresponding check box 216. In this example, application_1, or App_1 112 (FIG. 1), is selected for monitoring as well as an Application_2 and Application_4. A scroll bar 218 enables applications in the list of applications 214 that are not displayed due to size constraints of display screen 202 to be scrolled into view and presented for selection.

FIG. 6 is an illustration of GUI 148 (FIGS. 2 and 5) with Special File page 220 displayed. Monitor 104, display screen 202, title bar 204, windows buttons 206, menu bar 208 and scroll bar 216 remain the same as shown above in FIG. 5. Page menu 210 has a Special Files tab positioned forward among the tabs, indicating that the displayed page is Special File page 220.

A file selection list 222 displays some common files that might be the target of a backup whenever accessed. In this example, config_01 file 114 (FIG. 1), a config_04 file and data file_01 116 (FIG. 1) are selected for backup. A Browse button 224 enables a user to view and select files from the entire directory structure of computer 102 (FIG. 1), which of course can include remote files such as those on memory associated with server 122. Any file that can be accessed through the directory structure of computer 102, including those file accessible over the Internet or other communication media can be selected as targets of backup monitor 118.

FIG. 7 is an illustration of GUI 148 (FIGS. 2, 5 and 6) with Options page 230 displayed. Monitor 104, display screen 202, title bar 204, windows buttons 206, menu bar 208 and scroll bar 216 remain the same as shown above in FIGS. 5 and 6. Page menu 210 has Options tab positioned forward among the tabs, indicating that the displayed page is Options page 220. In this example, the available options are “Local Files Only,” “Modified Files,” “Accessed Files,” “Deleted Files,” “Size,” “Date,” “User Name,” and “Temporary Files.” Local Files Only, Modified Files and Accessed Files options 232 are selected and the remaining options 232 are not. Each of options 232 defines a particular file characteristic that causes a particular file displaying that characteristic to either be included or excluded from backup list 154 (FIG. 2).

Local Files Only option is set when the user desires to prevent the backup of files that stored in a remote memory structure. A selected Modified Files option indicates that any modification to a particular file should trigger a reference to the file to be included in backup list 154. Accessed files option indicates that a file access triggers a reference to the accessed file to be included in backup list 154. If Temporary Files option is set, then backup monitor 118 includes a reference to temporary files, i.e. files only used during the local processing but not necessary for subsequent execution of the application, to be included in backup list 154.

Size option enables a user to specify maximum and minimum or both with regard to the size of files to be included in backup file 154. Date option enables a user to set a time window with respect to files for inclusion. User Name option enables a user to target for backup the files of specific users in a multi-user system. Of course, for the most part, these filters can be combined to set complex criteria for files to be backed up. Options 232 are only examples of he various filters that may be employed. One with skill in the art should recognize that are numerous ways to classify files for the purposes of the claimed subject matter. Of course, for the most part, these filters can be combined to set complex criteria for files to be backed up.

While the invention has been shown and described with reference to particular embodiments thereof, it will be understood by those skilled in the art that the foregoing and other changes in form and detail may be made therein without departing from the spirit and scope of the invention, including but not limited to additional, less or modified elements and/or additional, less or modified blocks performed in the same or a different order.

We claim:

1. A method for creating a list of files for backup based upon program properties, comprising:
creating a backup monitor process;
marking an executable file for monitoring;
signaling the backup monitor process that a file has been accessed;
determining that the access was by the executable file; and
including a reference to the file accessed by the executable file in a list of files to be backed up.

2. The method of claim 1, further comprising:
marking a file as special;
detecting an access of the special file;
including a reference to the special file in the list of files to be backed up.

3. The method of claim 1, further comprising:
filtering a file to be included in the list of files to be backed up based upon whether the file exhibits a particular characteristic.

4. The method of claim 3, wherein the particular characteristic is that the files are stored on a particular computing system.

5. The method of claim 3, wherein the particular characteristic is that the access is a modification.

6. The method of claim 1, wherein the claimed functionality is integrated into an operating system.

7. The method of claim 1, the determination that the access was by the executable file further comprising correlating the signal with a particular marked executable file.

8. A backup monitor device for creating a list of files for backup based upon program properties, comprising:
logic for marking an executable file for monitoring;
logic for signaling the backup monitor process that a file has been accessed;
logic determining that the access was by the executable file; and
logic for including a reference to the file accessed by the executable file in a list of files to be backed up.

9. The backup monitor device of claim 8, further comprising:
logic for marking a file as special;
logic for detecting an access of the special file;
logic for including a reference to the special file in the list of files to be backed up.

10. The backup monitor device of claim 8, further comprising logic for filtering a file to be included in the list of files to be backed up based upon whether the file exhibits a particular characteristic.

11. The backup monitor device of claim 10, wherein the particular characteristic is that the files are stored on a particular computing system.

12. The backup monitor device of claim 10, wherein the particular characteristic is that the access is a modification.

13. The backup monitor device of claim 8, wherein the device is integrated into an operating system.

14. The backup monitor device of claim 8, the logic for determining that the access was by the executable file further comprising logic for correlating the signal with a particular marked executable file.

15. A computer programming product for creating a list of files for backup based upon program properties, comprising:
a memory;
a backup monitor process, stored on the memory, comprising;
logic, stored on the memory, for marking an executable file for monitoring;
logic, stored on the memory, for signaling the backup monitor process that a file has been accessed;
logic, stored on the memory, determining that the access was by the executable file; and
logic, stored on the memory, for including a reference to the file accessed by the executable file in a list of files to be backed up.

16. The computer programming product of claim 15, the backup monitor process further comprising:
logic, stored on the memory, for marking a file as special;
logic, stored on the memory, for detecting an access of the special file;
logic, stored on the memory, for including a reference to the special file in the list of files to be backed up.

17. The computer programming product of claim 15, the backup monitor process further comprising logic, stored on the memory, for filtering a file to be included in the list of files to be backed up based upon whether the file exhibits a particular characteristic.

18. The computer programming product of claim 17, wherein the particular characteristic is that the files are stored on a particular computing system.

19. The computer programming product of claim 17, wherein the particular characteristic is that the access is a modification.

20. The computer programming product of claim 15, wherein the computer programming product is integrated into an operating system.
